(19) United States
(12) Patent Application Publication
(10) Pub. No.: US 2016/0194507 A1
(43) Pub. Date: Jul. 7, 2016

(54) Quantum Dot Ink Formulation for Heat Transfer Printing Applications

(71) Applicant: Nanoco Technologies Ltd., Manchester (GB)

(72) Inventors: Nathalie Gresty, Chester (GB); Nigel Pickett, Manchester (GB)

(21) Appl. No.: 15/069,671

(22) Filed: Mar. 14, 2016

Related U.S. Application Data
(62) Division of application No. 14/484,749, filed on Sep. 12, 2014.
(60) Provisional application No. 61/877,593, filed on Sep. 13, 2013.

(51) Int. Cl. C09D 11/12; C09D 11/322; B41F 16/00; C09D 11/037

(52) U.S. Cl. CPC C09D 11/12; C09D 11/037; C09D 11/322; B41F 16/00

(57) ABSTRACT

A method of heat transfer printing using quantum dots is described. The method can be used to form an image using quantum dots on a substrate that is not easily printed using conventional printing techniques. Also described is a quantum dot ink formulation for heat transfer printing. The methods and materials can be used for anti-counterfeiting applications.

### CROSS-REFERENCE TO RELATED APPLICATIONS

This application is a division of U.S. application Ser. No. 14/484,749 filed Sep. 12, 2014, which claims priority to U.S. Provisional Application No. 61/877,593 filed Sep. 13, 2013, the disclosures of which are hereby incorporated by reference in their entireties.

### STATEMENT REGARDING FEDERALLY SPONSORED RESEARCH OR DEVELOPMENT

Not Applicable

### FIELD OF THE INVENTION

The invention relates to methods and materials for heat transfer printing using quantum dots.

### BACKGROUND

Heat transfer printing can be used to transfer a printed image onto a substrate by applying heat and optionally pressure. The technique provides a means to print an image onto a substrate that cannot easily be directly printed, due to its size, shape, and/or composition. Further, by careful formulation of the ink it is possible to transfer an image onto an absorbent substrate without color bleeding, an issue which often arises when printing directly onto textiles.

Advantages include that the thermal transfer process is environmentally friendly; there are no ink by-products and solvent evaporation during the thermal transfer process. In addition, the technique is cheap, requiring simply and readily available equipment: a suitable printer and a heat press. Thus, the technique can provide an affordable means of producing custom-made prints.

Several methods of heat transfer printing exist in the prior art. Typically, an image is printed on a sheet of paper using, for example, an ink-jet printer. Once the ink has dried, it is transferred onto a substrate under heat and pressure from a heat press, producing its mirror image on the substrate. A sub-category of this method is thermal wax transfer printing, whereby an image formed from a wax, rather than an ink, is thermally transferred onto the second substrate.

Using conventional heat transfer methods, the image produced is adhered to the substrate surface, thus is vulnerable to wear and tear. Protective coatings can therefore be applied, either concomitantly with the ink transfer, or thereafter, to improve the robustness of the image.

A second sub-classification of heat transfer printing is dye-sublimation printing, in which the dye is sublimable such that during the thermal transfer process the dye molecules sublime, i.e. convert from the solid to the gaseous phase, then back to a solid, enabling them to transfer from a printed sheet to a substrate and become embedded in the matrix of the substrate material.

Heat transfer printing is well-known in the prior art as a technique to produce visual images. However, it has not extensively been exploited to produce fluorescent images. Such fluorescent images can be applicable to anti-counterfeiting applications, including fluorescent barcoding and holograms, as well as for consumer products.

U.S. Pat. No. 7,989,390 describes a method of thermally transferring an image printed from an ink containing one or more organic fluorophores, to create an image with a high level of forgery prevention. However, organic dyes are known to be readily susceptible to photobleaching and oxygen quenching. Further, their narrow absorption spectra means precise excitation wavelengths are required to photo-excite the chromophores. Therefore, when using a combination of organic fluorescent agents, several excitation sources would be needed to excite all the dyes simultaneously.

Therefore, there is a need for a series of fluorescent agents with narrow emission spectra but sufficiently broad absorption spectra to be excited simultaneously using a single, monochromatic excitation source.

U.S. Pat. No. 6,692,031 describes a means of using quantum dots (QDs) to form a fluorescent signature that can be detected using an optical reader. A mixture of QDs with different emission wavelengths can be used to produce a random pattern with fluorescence that is spectrally varied, providing a high level of counterfeiting prevention. CdSe/ZnSe QDs are proposed for suspension in a transparent UV-curable resin, which can be used to form an ink. The ink can be printed on an adhesive-coated paper with a peel-off backing to produce selfadhesive labels. However, there is not indication that the ink is applicable by any heat transfer process.

Patent Application WO 2011/058030 combines conventional dyes with epoxy/acrylate resins, crosslinking agents and polyester-based polymers to form a thermally transferrable image.

The European Patent No. 2 042 536 discloses a thermally curable powder coating composition based on a hydroxyl functional polyester resin with high hydroxyl value blended with a low hydroxyl value resin; both are cured with a self-blocked uretdione. The invention can be used for transfer printing, to produce a colored image.

Application No. WO 2004/022352 and European Patent No. 1 545 883 A4 describe an ink-jet ink formulation for use in secondary transfer processes. The ink-jet ink composition contains a pre-dispersion, comprising one or more sublimation dyes, and an ink-jet ink containing at least one non-sublimable colorant. Upon sublimation, a monochromatic intermediate transfer substrate is formed, from which a multi-coloured image is transferred to a substrate via the application of heat and pressure. The monochromatic image is created from the non-sublimable colorant, and provides a copy of the transfer image, eliminating the need to use computer software to reverse the printed image to replicate the transferred image. The multicolored transfer image is created at high temperature and pressure, by sublimation of the sublimation dye and subsequent bonding to the substrate. Limitations of this method include that the ink formulation is only compatible with ink-jet printing, and the invention only proposes the use of colored dyes.

EP Patent No. 1 533 348 describes an ink formulation for sublimation transfer and a transfer method. The sublimation dye is used in a piezo ink-jet system, which reduces environmental pollution, prevents nozzle clogging, and has good long-term storage stability. The invention uses a sugar alcohol as a humectant in an aqueous dye system, to alleviate the issue of environmental pollution during thermal transfer as the solvent evaporates when using an organic solvent system. In addition to only being proposed for use with conventional, rather than fluorescent, dyes, this ink formulation requires long heating times (up to ten minutes). Such excessive heating times could limit the number of substrates onto which the image could be transferred.

In summary, the ink formulations for heat transfer printing described in the prior art either employ conventional colored dyes or organic fluorophores with narrow absorption spectra. Thus, there is a need in the art for a method of heat transfer printing using fluorescent materials with a broad emission spectrum and that are tolerant to the heat transfer process.

### SUMMARY

The disclosed methods provide a cheap and quick printing method. The image can be transferred onto a variety of substrates, many of which would not necessarily be printable using conventional printing techniques. The methods can also be used to transfer an image onto a substrate that can be printed, but for which directly printing the ink onto the substrate may be undesirable. For instance, printing an ink directly onto a textile may be unfavorable due to bleeding as the solvent wets the material fibers. Using the current methods, in which the ink is printed onto a transfer sheet that is not as easily wetted by the ink and the solvent is allowed to evaporate prior to thermal transfer onto the substrate, color bleeding is avoided.

The printing and heat transfer methods require inexpensive equipment. For instance, with correct formulation the QD ink could be loaded into domestic ink-jet printer cartridges. Thermal transfer sheets are readily available and, if bought in bulk, cost as little as a few pence per sheet. Similarly, heat presses can be bought for as little as a few hundred pounds.

QDs are more resistant to quenching than organic dyes. By encapsulating the QDs, their stability is greatly enhanced, providing resistance to oxidation and photobleaching. In the emission wavelength of QDs can be easily tuned by controlling the nanoparticle size during synthesis, unlike organic dyes for which a different fluorophore is required to achieve a different emission wavelength.

QDs typically exhibit higher fluorescence quantum yields than organic dyes, with lower signal-to-noise ratios. As such, a smaller amount of QD material would be required to achieve the same fluorescence intensity.

Quantum dots have a broader absorption peak and narrower, more symmetrical emission peak than organic fluorophores; this means that quantum dots emitting at multiple wavelengths can be excited using a single excitation wavelength, which is advantageous for anticounterfeiting. Owing to their narrow emission, peak overlap can be avoided. In contrast, organic fluorophores would require multiple excitation sources to excite a range of emission wavelengths.

Due to the large Stokes shift between the absorption and emission peaks, visibleemitting QD inks may appear one color under ambient light, and fluoresce at a different color under UV light. Therefore, QDs can be used both as a standard dye under ambient conditions, that will fluoresce under UV light. This could be advantageous for signage applications.

Using IR-emitting quantum dots, on an appropriately colored substrate the ink would not necessarily be detectable under ambient light, which would be advantageous for anticounterfeiting applications.

The QDs can be used in combination with conventional dyes, either in the same ink formulation or separately. This can be used to produce different images depending on whether the substrate is viewed under ambient or UV light. This could be advantageous for anticounterfeiting applications, e.g. to produce bank notes or credit cards that contain a fluorescent hologram that would be inconspicuous under ambient light. It could also be useful for decorative applications, such as soft signage, providing a means to transform an image simply by altering the lighting conditions.

Using QD beads, quantum dots emitting at different wavelengths can be incorporated into the same bead. Such beads could be used to produce an image that appears one uniform colour under ambient light, but would fluoresce at a range of different wavelengths under UV irradiation. By incorporating a range of quantum dots into the ink in this way, an emission profile could be produced that would be very difficult to counterfeit. Further, the multi-wavelength QD dye could be printed from a single ink, therefore either a simpler printing technique (e.g. Dr. Blading as opposed to ink-jet printing) and/or fewer printing steps would be required to deposit a very complex fluorescence emission profile.

In summary, the method provides a cheap and accessible means to form a fluorescent image on a range of substrates. The foregoing summary is not intended to summarize each potential embodiment or every aspect of the present disclosure.

### BRIEF DESCRIPTION OF THE DRAWING(S)

FIG. 1 is a flow chart outlining the basic stages of thermal transfer printing.

FIG. 2 illustrates a method of forming red- and green-emitting QD inks from QD beads where the red and green emitters are incorporated into the same bead (left) or are formed into red and green beads (right), which are then combined in the ink formulation.

### DETAILED DESCRIPTION

Ink containing fluorescent quantum dots (QDs) for heat transfer printing is described herein. QDs are luminescent semiconductor nanoparticles, typically with diameters between 120 nm, which demonstrate size quantization effects. As the nanoparticle size decreases, the electronic wave-function becomes confined to increasingly smaller dimensions, such that the properties of the nanoparticle become intermediate between those of the bulk material and individual atoms, a phenomenon known as “quantum confinement.” The band gap becomes larger as the nanoparticle size is reduced, and the nanoparticles develop discrete energy levels, rather than a continuous energy band as observed in bulk semiconductors. Thus, nanoparticles emit at a higher energy than that of the bulk material. Due to Coulombic interactions, which cannot be neglected, quantum dots have higher kinetic energy than their bulk counterparts, thus a narrow bandwidth, and the band gap increases in energy as the particle size decreases. Thus, the color emitted by QDs can be controlled by tuning the nanoparticle size.

QDs made from a single semiconducting material passivated by an organic layer on the surface are known as “cores.” Cores tend to have relatively low quantum efficiency, since electron-hole recombination is a facilitated by defects and dangling bonds on the surface of the nanoparticles, leading to non-radiative emission. Several approaches are used to enhance the quantum efficiency. The first approach is to synthesize a “core/shell” nanoparticle, in which a “shell” layer of a wider band gap material is grown epitaxially on the surface of the core; this serves to eliminate the surface defects and dangling bonds, thus preventing non-radiative emission. Examples of core/shell materials include CdSe/ZnS and InP/ZnS. A second approach is to grow core/multi-shell, “quantum dot-quantum well,” materials. In this system, a thin layer of a narrow band gap material is grown on the surface of a wide band gap core, and then a final layer of the wide band gap material is grown on the surface of the narrower band gap shell. This approach ensures that all photo-excited carriers are confined to the narrower band gap layer, resulting in a high photoluminescence quantum yield (PLQY) and improving stability. Examples include CdS/HgS/CdS and AlAs/GaAs/AlAs. A third technique is to grow a “graded shell” QD, where a compositionally-graded alloy shell is grown epitaxially on the core surface; this serves to eliminate defects resulting from strain that often arises from the lattice mismatch between the core and shell in core/shell nanoparticles. One such example is CdSe/Cd1-xZnxSe1-ySy. Graded shell QDs typically have PLQYs in the region of 70-80%.

The coordination around the atoms on the surface of any core, core/shell or core/multishell, doped or graded nanoparticle is incomplete and the non-fully coordinated atoms have dangling bonds which make them highly reactive and can lead to particle agglomeration. This problem is overcome by passivating (capping) the “bare” surface atoms with protecting organic groups.

The outermost layer (capping agent) of organic material or sheath material helps to inhibit particle-particle aggregation, further protects the nanoparticle from their surrounding electronic and chemical environments and also provides a mean of chemical linkage to other inorganic, organic or biological material. In many cases, the capping agent is the solvent that the nanoparticle preparation is undertaken in, and consists of a Lewis base compound, or a Lewis base compound diluted in an inert solvent such as a hydrocarbon. There is a lone pair of electrons on the Lewis base capping agent that are capable of a donor type coordination to the surface of the nanoparticle and include mono- or multi-dentate ligands such as phosphines (trioctylphosphine, triphenylphosphine, t-butylphosphine, etc.), phosphine oxides (trioctylphosphine oxide, triphenylphosphine oxide, etc.), alkyl phosphonic acids, alkyl-amines (octadecylamine, hexadecylamine, octylamine, etc.), aryl-amines, pyridines, long chain fatty acids (myristic acid, oleic acid, undecylenic acid, etc.) and thiophenes but is, as one skilled in the art will know, not restricted to these materials.

The outermost layer (capping agent) of a quantum dot can also consist of a coordinated ligand with additional functional groups that can be used as chemical linkage to other inorganic, organic or biological material, whereby the functional group is pointing away from the quantum dot surface and is available to bond/react/interact with other available molecules, such as amines, alcohols, carboxylic acids, esters, acid chloride, anhydrides, ethers, alkyl halides, amides, alkenes, alkanes, alkynes, allenes, amino acids, azide groups, etc. but is, as one skilled in the art will know, not limited to these functionalised molecules. The outermost layer (capping agent) of a quantum dot can also consist of a coordinated ligand with a functional group that is polymerisable and can be used to form a polymer layer around the particle.

The outermost layer (capping agent) can also consist of organic units that are directly bonded to the outermost inorganic layer such as via an S—S bond between the inorganic surface (ZnS) and a thiol capping molecule. These can also possess additional functional group(s), not bonded to the surface of the particle, which can be used to form a polymer around the particle, or for further reaction/interaction/chemical linkage.

As-synthesized QDs are traditionally intolerant to high-temperature processing conditions, since increased temperatures can lead to thermal population of excited states by charge carriers, which then recombine non-radiatively. Processing at elevated temperatures is advantageous for display applications, thus methods to enhance the thermal stability of QDs have been developed to assist their processability.

One such method is to incorporate the QDs into a bead. U.S. Patent Application Publication No. 2010/0123155 describes the preparation of “QD-beads”, in which QDs are encapsulated into microbeads comprising an optically transparent medium. For opto-electronic applications, the QD-beads are then embedded in a host LED encapsulation medium, however QD formulations could equally be used to prepare a printable QD ink. Bead diameters can range from 20 nm to 0.5 mm, which can be used to control the viscosity of the QD-bead ink and the resulting properties, such as ink flow, drying, and adhesion to a substrate. QD-beads offer enhanced stability to mechanical and thermal processing relative to “bare” QDs, as well as improved stability to moisture, air, and photo-oxidation, allowing potential for processing in air, which reduces manufacturing costs. By encapsulating the QDs into beads, they are also protected from the potentially damaging chemical environment of the encapsulation medium. Microbead encapsulation also serves to eliminate the agglomeration that is detrimental to the optical performance of bare printed QDs. Since the surface of the nanoparticles is not drastically disrupted or modified, the QDs retain their electronic properties when encapsulated in microbeads, allowing tight control over the QD-bead ink specification.

Other approaches are centered on enhancing the inherent thermal stability of the QD by confining the excitons within the core, such that they become largely insensitive to environmental factors such as temperature and atmosphere. Htoon et al. reported the synthesis of “giant” CdSe/CdS QDs with optical characteristics that were largely insensitive to high temperature processing conditions [H. Htoon, A. V. Malko, D. Bussian, J. Vela, Y. Chen, J. A. Hollingsworth & V. I. Klimov, J. Am. Chem. Soc., 2008, 130, 5026]. In these so-called “giant” QDs a thick shell (ten or more monolayers) of a wider bandgap material is grown epitaxially on a standard, narrower bandgap QD core. To alleviate strain effects that are typically induced due to the lattice mismatch between the core and shell materials, the shell is typically composed of a compositionally graded alloy. Alloying further serves to randomise the energy levels between the core and shell, increasing the confinement of electron and hole wavefunctions within the middle layers of the nanoparticle.

Another approach is to synthesize large (>10 nm), ternary alloyed cores with a relatively thin shell, as described in U.S. Patent Application Publication No. 2011/0175030. By alloying the cores it is possible to maintain a relatively wide band gap compared to those of the respective binary quantum dots, while physically increasing the nanoparticle size. Thus, relatively large nanoparticles can display the luminescent properties typical of much smaller quantum dots. The larger physical dimensions of these particles reduce the surface area to volume ratio, thus reducing surface effects. As such, large ternary alloyed core/shell nanoparticles are considerably insensitive to their surrounding chemical and physical environment. In another patent application (U.S. Patent Application Publication No. 2010/0289003), large-sized, compositionally graded alloy core/shell QDs are synthesized such that the core and shell optimally have different crystal structures. This enhances the randomization of the energy levels achieved by compositionally graded alloying, to promote the confinement of charge carriers to the region of the core/shell interface and thus reduce their sensitivity to temperature changes.

Thus far, techniques to enhance the stability of QDs to high temperatures have not been exploited for heat transfer printing processes. In the present disclosure, by combining QDs into an ink formulation suitable for heat transfer printing, a process to produce fluorescent images on a wide array of substrates is provided. The method is inexpensive, requiring only commercially available equipment and relatively benign processing conditions.

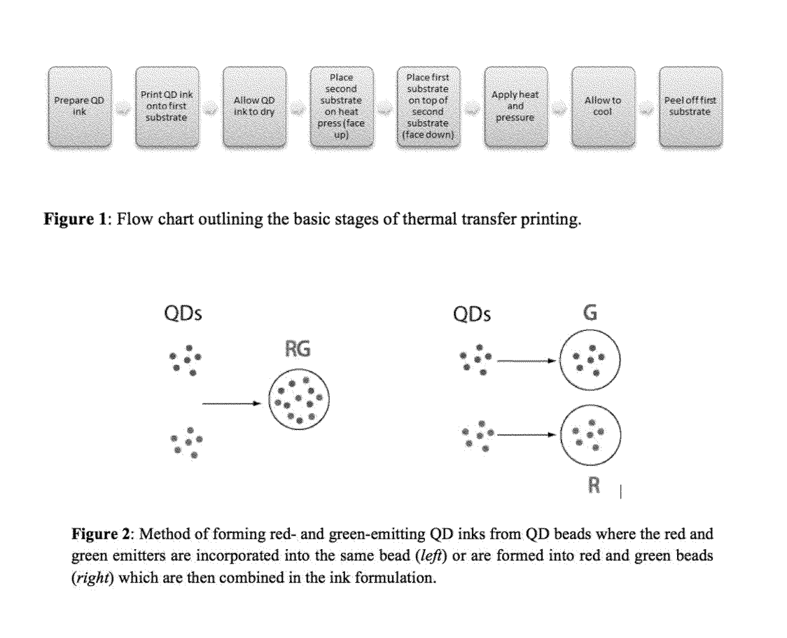

The basic stages of thermal transfer printing using QDs are outlined in FIG. 1. The method can include: preparing a QD ink; printing the ink onto a first substrate; allowing the ink to dry; placing a second substrate, face up, on a heat press; placing the first substrate, face down, on top of the second substrate; applying heat and pressure; allowing the substrates to cool; and peeling the first substrate off the second substrate. The thermal transfer process employs relatively cheap and readily available equipment, e.g. a printer (ink-jet printer, screen printer, doctor blade, etc.) to deposit the quantum dot ink and a heat press to transfer the dried ink to the second substrate. Therefore, the technique provides a readily available process to transfer QD images from one substrate to another.

A number of different thermal transfer processes can be employed. In conventional heat transfer printing, the dye is incorporated into an ink formulation typically including polymer-based binders or resins that melt and fuse at the process transfer temperature. The dye is thus transferred onto the surface of the second substrate. Further coatings can subsequently be applied to impart additional functionality such as scratch-resistance.

A second technique, thermal wax transfer, incorporates the dye into a wax. The wax can be applied to the first substrate as a solid, e.g. by rubbing like a crayon or by pre-forming an image in a mold that can be stamped onto the substrate, or the wax can be melted and added as a liquid by a suitable coating technique. Alternatively, the wax can be incorporated into an ink formulation and printed onto the first substrate. During the thermal transfer printing process the dye-containing wax is melted and fused to the surface of the second substrate.

In a third technique, dye-sublimation transfer printing, the dye molecules within the ink sublime during the thermal transfer process, becoming incorporated into the matrix of the second substrate. Using this technique, since the dye molecules are embedded into the second substrate, scratch-resistance is provided without further coating. The image is also resistant to washing.

### Thermal Transfer Ink Formulation and Transfer Process

The ink formulation comprises QDs or QD beads, one or more binders, and a solvent. Further additives may be incorporated into the ink formulation to alter its properties, such as rheology, processability, shelf-life, etc.

The QD ink described herein is optimally formulated using core/shell (including multishell and/or compositionally graded alloy shell architectures) semiconductor nanoparticles.

The core material can be made from: II-IV compounds including a first element from group 12(II) of the periodic table and a second element from group 16 (VI) of the periodic table, as well as ternary and quaternary materials including, but not restricted to: CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdHgSeS, CdHgSeTe, CdHgSTe, HgZnSeS, HgZnSeTe.

II-V compounds incorporating a first element from group 12 of the periodic table and a second element from group 15 of the periodic table, and also including ternary and quaternary materials and doped materials. Nanoparticle material includes, but is not restricted to: Zn₃P₂, Zn₃As₂, Cd₃P₂, Cd₃As₂, Cd₃N₂, Zn₃N₂.

III-V compounds including a first element from group 13 (III) of the periodic table and a second element from group 15 (V) of the periodic table, as well as ternary and quaternary materials. Examples of nanoparticle core materials include, but are not restricted to: BP, AlP, AlAs, AlSb, GaN, GaP, GaAs, GaSb; InN, InP, InAs, InSb, AlN, BN, GaNP, GaNAs, InNP, InNAs, GAlnPAs, GaAlPAs, GaAlPSb, GaInNSb, InAlNSb, InAlPAs, InAlPSb.

III-VI compounds including a first element from group 13 of the periodic table and a second element from group 16 of the periodic table and also including ternary and quaternary materials. Nanoparticle material includes, but is not restricted to: Al₂S₃, Al₂Se₃, Al₂Te₃, Ga₂S₃, Ga₂Se₃, In₂S₃, In₂Se₃, Ga₂Te₃, In₂Te₃.

IV compounds including elements from group 14 (IV): Si, Ge, SiC, SiGe.

IV-VI compounds including a first element from group 14 (IV) of the periodic table and a second element from group 16 (VI) of the periodic table, as well as ternary and quaternary materials including, but not restricted to: PbS, PbSe, PbTe, SnSeS, SnSeTe, SnSTe, PbSeS, PbSeTe, PbSTe, SnPbSe, SnPbTe, SnPbSeTe, SnPbSTe.

The shell layer(s) grown on the nanoparticle core may comprise any one or more of the following materials, including their compositionally graded alloys:

IIA-VIB (2-16) material, incorporating a first element from group 2 of the periodic table and a second element from group 16 of the periodic table, and also including ternary and quaternary materials and doped materials. Nanoparticle material includes, but is not restricted to: MgS, MgSe, MgTe, CaS, CaSe, CaTe, SrS, SrSe, SrTe.

IIB-VIB (12-16) material incorporating a first element from group 12 of the periodic table and a second element from group 16 of the periodic table, and also including ternary and quaternary materials and doped materials. Nanoparticle material includes, but is not restricted to: ZnS, ZnSe, ZnTe, CdS, CdSe, CdTe, HgS, HgSe, HgTe.

II-V material incorporating a first element from group 12 of the periodic table and a second element from group 15 of the periodic table, and also including ternary and quaternary materials and doped materials. Nanoparticle material includes, but is not restricted to: Zn₃P₂, Zn₃As₂, Cd₃P₂, Cd₃As₂, Cd₃N₂, Zn₃N₂.

III-V material incorporating a first element from group 13 of the periodic table and a second element from group 15 of the periodic table, and also including ternary and quaternary materials and doped materials. Nanoparticle material includes, but is not restricted to: BP, AlP, AlAs, AlSb, GaN, GaP, GaAs, GaSb, InN, InP, InAs, InSb, AlN, BN.

III-IV material incorporating a first element from group 13 of the periodic table and a second element from group 14 of the periodic table, and also including ternary and quaternary materials and doped materials. Nanoparticle material includes, but is not restricted to: B₄C, Al₄C₃, Ga₄C.

III-VI material incorporating a first element from group 13 of the periodic table and a second element from group 16 of the periodic table, and also including ternary and quaternary materials. Nanoparticle material includes, but is not restricted to: Al₂S₃, Al₂Se₃, Al₂Te₃, Ga₂S₃, Ga₂Se₃, In₂S₃, In₂Se₃, Ga₂Te₃, In₂Te₃.

IV-VI material incorporating a first element from group 14 of the periodic table and a second element from group 16 of the periodic table, and also including ternary and quaternary materials and doped materials. Nanoparticle material includes, but is not restricted to: PbS, PbSe, PbTe, Sb₂Te₃, SnS, SnSe, SnTe.

Nanoparticle material incorporating a first element from any group in the d-block of the periodic table, and a second element from any group 16 of the periodic table, and also including ternary and quaternary materials and doped materials. Nanoparticle material includes, but is not restricted to: NiS, CrS, CuInS₂, CuInSe₂, CuGaS₂, CuGaSe₂.

The coordination around the atoms on the surface of any core, core/shell or core/multishell, doped or graded nanoparticle is incomplete and the non-fully coordinated atoms have dangling bonds which make them highly reactive and can lead to particle agglomeration. This problem is overcome by passivating (capping) the “bare” surface atoms with protecting organic groups.

The outermost layer (capping agent) of organic material or sheath material helps to inhibit particle-particle aggregation, further protecting the nanoparticles from their surrounding electronic and chemical environments. The capping agent can be selected to provide solubility in an appropriate solvent, chosen for its printability properties (viscosity, volatility, etc.). In many cases, the capping agent is the solvent in which the nanoparticle preparation is undertaken, and consists of a Lewis base compound, or a Lewis base compound diluted in an inert solvent such as a hydrocarbon. There is a lone pair of electrons on the Lewis base capping agent that is capable of a donor-type coordination to the surface of the nanoparticle and include mono- or multidentate ligands such as phosphines (trioctylphosphine, triphenylphosphine, t-butylphosphine, etc.), phosphine oxides (trioctylphosphine oxide, triphenylphosphine oxide, etc.), alkyl phosphonic acids, alkyl-amines (octadecylamine, hexadecylamine, octylamine, etc.), arylamines, pyridines, long chain fatty acids (myristic acid, oleic acid, undecylenic acid, etc.) and thiophenes but is, as one skilled in the art will know, not restricted to these materials.

The outermost layer (capping agent) of a QD can also consist of a coordinated ligand with additional functional groups that can be used as chemical linkage to other inorganic, organic or biological material, whereby the functional group is pointing away from the QD surface and is available to bond/react/interact with other available molecules, such as amines, alcohols, carboxylic acids, esters, acid chloride, anhydrides, ethers, alkyl halides, amides, alkenes, alkanes, alkynes, allenes, amino acids, azide groups, etc. but is, as one skilled in the art will know, not limited to these functionalized molecules. The outermost layer (capping agent) of a QD can also consist of a coordinated ligand with a functional group that is polymerizable and can be used to form a polymer layer around the particle.

The outermost layer (capping agent) can also consist of organic units that are directly bonded to the outermost inorganic layer such as via an S—S bond between the inorganic surface (ZnS) and a thiol capping molecule. These can also possess additional functional group(s), not bonded to the surface of the particle, which can be used to form a polymer around the particle, or for further reaction/interaction/chemical linkage.

The ink described herein can be fabricated with “bare” QDs dispersed directly into the solvent formulation, or more preferably, they can be incorporated into microbeads prior to their dispersion into the solvent; the QD microbeads exhibit superior robustness, and longer lifetimes than bare QDs, and are more stable to the mechanical and thermal processing protocols of the heat transfer process. By incorporating the QD material into polymer microbeads, the nanoparticles become more resistant to air, moisture and photo-oxidation, opening up the possibility for processing in air that would vastly reduce the manufacturing cost. The bead size can be tuned from 20 nm to 0.5 mm, enabling control over the ink viscosity without changing the inherent optical properties of the QDs. The viscosity dictates how the QD bead ink flows through a mesh, dries, and adheres to a substrate, so thinners are not required to alter the viscosity, reducing the cost of the ink formulation. By incorporating the QDs into microbeads, the detrimental effect of particle agglomeration on the optical performance of bare encapsulated QDs is eliminated.

QD beads provide an effective means of color mixing, which is applicable to optical barcoding, so obtain a unique emission profile from a range of QDs with different emission wavelengths; a QD bead can be made with either a mixture of different colored QDs (FIG. 2 left), or alternatively several QD beads, each containing a different single color of QDs, can be combined to form an ink (FIG. 2 right). An ink prepared using either of the methods in FIG. 2 will emit both in the red and green regions of the visible spectrum. Thus by combining a plurality of different colored QDs in different relative concentrations, it is possible to form a “fluorescent barcode” with an emission spectrum that is formed by convoluting the emission spectra of each colour of QDs, which would be difficult to counterfeit.

One such method for incorporating QDs into microbeads involves growing the polymer bead around the QDs. A second method incorporates QDs into pre-existing microbeads.

With regard to the first option, by way of example, hexadecylamine-capped CdSe-based semiconductor nanoparticles can be treated with at least one, more preferably two or more polymerizable ligands (optionally one ligand in excess) resulting in the displacement of at least some of the hexadecylamine capping layer with the polymerizable ligand(s). The displacement of the capping layer with the polymerizable ligand(s) can be accomplished by selecting a polymerizable ligand or ligands with structures similar to that of trioctylphosphine oxide (TOPO), which is a ligand with a known and very high affinity for CdSe-based nanoparticles. It will be appreciated that this basic methodology may be applied to other nanoparticle/ligand pairs to achieve a similar effect. That is, for any particular type of nanoparticle (material and/or size), it is possible to select one or more appropriate polymerizable surface binding ligands by choosing polymerizable ligands comprising a structural motif, which is analogous in some way (e.g. has a similar physical and/or chemical structure) to the structure of a known surface binding ligand. Once the nanoparticles have been surface-modified in this way, they can then be added to a monomer component of a number of microscale polymerization reactions to form a variety of QD-containing resins and beads. Another option is the polymerization of one or more polymerizable monomers from which the optically transparent medium is to be formed in the presence of at least a portion of the semiconductor nanoparticles to be incorporated into the optically transparent medium. The resulting materials incorporate the QDs covalently and appear highly colored even after prolonged periods of Soxhlet extraction.

Examples of polymerization methods that may be used to construct QD-containing beads include, but are not restricted to, suspension, dispersion, emulsion, living, anionic, cationic, RAFT, ATRP, bulk, ring-closing metathesis and ring-opening metathesis. Initiation of the polymerization reaction may be induced by any suitable method that causes the monomers to react with one another, such as by the use of free radicals, light, ultrasound, cations, anions, or heat. A preferred method is suspension polymerization, involving thermal curing of one or more polymerizable monomers from which the optically transparent medium is to be formed. Said polymerizable monomers may comprise methyl (meth)acrylate, ethylene glycol dimethacrylate and vinyl acetate. This combination of monomers has been shown to exhibit excellent compatibility with existing commercially available encapsulants (e.g. those used for LED manufacture) and has been used to fabricate a light emitting device exhibiting significantly improved performance compared to a device prepared using essentially prior art methodology. Other examples of polymerizable monomers are epoxy or polyepoxide monomers, which may be polymerized using any appropriate mechanism, such as curing with ultraviolet irradiation.

QD-containing microbeads can be produced by dispersing a known population of QDs within a polymer matrix, curing the polymer and then grinding the resulting cured material. This is particularly suitable for use with polymers that become relatively hard and brittle after curing, such as many common epoxy or polyepoxide polymers (e.g. Optocast™ 3553 UV and/or heat curable epoxy from Electronic Materials, Inc., USA).

QD-containing beads may be generated simply by adding QDs to the mixture of reagents used to construct the beads. In some instances, nascent QDs will be used as isolated from the reaction employed for their synthesis, and are thus generally coated with an inert outer organic ligand layer. In an alternative procedure, a ligand exchange process may be carried out prior to the bead-forming reaction. Here, one or more chemically reactive ligands (for example a ligand for the QDs that also contains a polymerizable moiety) are added in excess to a solution of nascent QDs coated in an inert outer organic layer. After an appropriate incubation time the QDs are isolated, for example by precipitation and subsequent centrifugation, washed and then incorporated into the mixture of reagents used in the bead forming reaction/process.

Both QD incorporation strategies will result in statistically random incorporation of the QDs into the beads and thus the polymerization reaction will result in beads containing statistically similar amounts of the QDs. It will be obvious to one skilled in the art that bead size can be controlled by the choice of polymerization reaction used to construct the beads, and additionally once a polymerization method has been selected bead size can also be controlled by selecting appropriate reaction conditions, e.g. by stirring the reaction mixture more quickly in a suspension polymerization reaction to generate smaller beads. Moreover, the shape of the beads can be readily controlled by choice of procedure in conjunction with whether or not the reaction is carried out in a mold. The composition of the beads can be altered by changing the composition of the monomer mixture from which the beads are constructed. Similarly, the beads can also be cross-linked with varying amounts of one or more cross-linking agents (e.g. divinyl benzene). If beads are constructed with a high degree of cross-linking, e.g. greater than 5 mol. % cross-linker, it may be desirable to incorporate a porogen (e.g. toluene or cyclohexane) during the bead-forming reaction. The use of a porogen in such a way leaves permanent pores within the matrix constituting each bead. These pores may be sufficiently large to allow the ingress of QDs into the bead.

QDs can also be incorporated in beads using reverse emulsion-based techniques. The QDs may be mixed with precursor(s) to the optically transparent coating material and then introduced into a stable reverse emulsion containing, for example, an organic solvent and a suitable salt. Following agitation the precursors form microbeads encompassing the QDs, which can then be collected using any appropriate method, such as centrifugation. If desired, one or more additional surface layers or shells of the same or a different optically transparent material can be added prior to isolation of the QD-containing beads by addition of further quantities of the requisite shell layer precursor material(s).

In respect of the second option for incorporating QDs into beads, the QDs can be immobilized in polymer beads through physical entrapment. For example, a solution of QDs in a suitable solvent (e.g. an organic solvent) can be incubated with a sample of polymer beads. Removal of the solvent using any appropriate method results in the QDs becoming immobilized within the matrix of the polymer beads. The QDs remain immobilized in the beads unless the sample is re-suspended in a solvent (e.g. organic solvent) in which the QDs are freely soluble. Optionally, at this stage the outside of the beads can be sealed. Alternatively, at least a portion of the QDs can be physically attached to prefabricated polymer beads. Said attachment may be achieved by immobilization of the portion of the semiconductor nanoparticles within the polymer matrix of the prefabricated polymeric beads or by chemical, covalent, ionic, or physical connection between the portion of semiconductor nanoparticles and the prefabricated polymeric beads. Examples of prefabricated polymeric beads comprise polystyrene, polydivinyl benzene and a polythiol.

QDs can be irreversibly incorporated into prefabricated beads in a number of ways, e.g. chemical, covalent, ionic, physical (e.g. by entrapment) or any other form of interaction. If prefabricated beads are to be used for the incorporation of QDs, the solvent accessible surfaces of the bead may be chemically inert (e.g. polystyrene) or alternatively they may be chemically reactive/functionalized (e.g. Merrifield's Resin). The chemical functionality may be introduced during the construction of the bead, for example by the incorporation of a chemically functionalized monomer, or alternatively chemical functionality may be introduced in a postbead construction treatment, for example by conducting a chloromethylation reaction. Additionally, chemical functionality may be introduced by a post-bead construction polymeric graft or other similar process whereby chemically reactive polymer(s) are attached to the outer layers/accessible surfaces of the bead. More than one such post-construction derivation process may be carried out to introduce chemical functionality onto/into the bead.

As with QD incorporation into beads during the bead forming reaction, i.e. the first option described above, the pre-fabricated beads can be of any shape, size and composition, may have any degree of cross-linker, and may contain permanent pores if constructed in the presence of a porogen. QDs may be imbibed into the beads by incubating a solution of QDs in an organic solvent and adding this solvent to the beads. The solvent must be capable of wetting the beads and, in the case of lightly cross-linked beads, preferably 0-10% cross-linked and most preferably 0-2% cross-linked, the solvent should cause the polymer matrix to swell in addition to solvating the QDs. Once the QD-containing solvent has been incubated with the beads, it is removed, for example by heating the mixture and causing the solvent to evaporate, and the QDs become embedded in the polymer matrix constituting the bead or alternatively by the addition of a second solvent in which the QDs are not readily soluble but which mixes with the first solvent causing the QDs to precipitate within the polymer matrix constituting the beads. Immobilization may be reversible if the bead is not chemically reactive, or else if the bead is chemically reactive the QDs may be held permanently within the polymer matrix by chemical, covalent, ionic, or any other form of interaction.

Optically transparent media that are sol-gels and glasses, intended to incorporate QDs, may be formed in an analogous fashion to the method used to incorporate QDs into beads during the bead-forming process as described above. For example, a single type of QD (e.g. one color) may be added to the reaction mixture used to produce the sol-gel or glass. Alternatively, two or more types of QD (e.g. two or more colors) may be added to the reaction mixture used to produce the sol-gel or glass. The sol-gels and glasses produced by these procedures may have any shape, morphology or 3-dimensional structure. For example, the particles may be spherical, disc-like, rod-like, ovoid, cubic, rectangular, or any of many other possible configurations.

By incorporating QDs into beads in the presence of materials that act as stabilityenhancing additives, and optionally providing the beads with a protective surface coating, migration of deleterious species, such as moisture, oxygen and/or free radicals, is reduced if not entirely eliminated, with the result of enhancing the physical, chemical and/or photo-stability of the semiconductor nanoparticles.

An additive may be combined with “bare” semiconductor nanoparticles and precursors at the initial stages of the production process of the beads. Alternatively or additionally, an additive may be added after the semiconductor nanoparticles have been entrapped within the beads.

The additives that may be added singly or in any desirable combination during the bead formation process can be grouped according to their intended function, as follows:

Mechanical sealing: fumed silica (e.g. Cab-O-Sil™), ZnO, TiO2, ZrO, Mg stearate, Zn stearate, all used as a filler to provide mechanical sealing and/or reduce porosity.

Capping agents: tetradecyl phosphonic acid (TDPA), oleic acid, stearic acid, polyunsaturated fatty acids, sorbic acid, Zn methacrylate, Mg stearate, Zn stearate, isopropyl myristate. Some of these have multiple functionalities and can act as capping agents, free-radical scavengers and/or reducing agents.

Reducing agents: ascorbic acid palmitate, alpha tocopherol (vitamin E), octane thiol, butylated hydroxyanisole (BHA), butylated hydroxytoluene (BHT), gallate esters (propyl, lauryl, octyl, etc.), a metabisulfite (e.g. the sodium or potassium salt).

Free radical scavengers: benzophenones.

Hydride reactive agents: 1,4-butandiol, 2-hydroxyethyl methacrylate, allyl methacrylate, 1,6-heptadiene-4-ol, 1,7-octadiene, and 1,4-butadiene.

The selection of the additive(s) for a particular application will depend upon the nature of the semiconductor nanoparticle material (e.g. how sensitive the nanoparticle material is to physical, chemical and/or photo-induced degradation), the nature of the primary matrix material (e.g. how porous it is to potentially deleterious species, such as free-radicals, oxygen, moisture, etc.), the intended function of the final material onto which the primary particles are printed (e.g. the conditions in which it is intended to be used), and the heat transfer processing conditions. As such, one or more appropriate additives can be selected from the above five lists to suit any desirable heat transfer printed semiconductor nanoparticle application.

Further stability to high temperature processing conditions can be achieved using an atomic layer deposition (ALD) process to shell the QD beads, as described in U.S. patent application Ser. No. 14/208,311, filed Mar. 13, 2014, the entire contents of which are incorporated herein by reference. The ALD process can be used to coat QD beads with a moisture barrier such as, but not restricted, to Al₂O₃. The process is intended to enhance the lifetime of the QD beads without negatively impacting on their optical properties.

To formulate the ink, the QDs or QD beads are first dispersed in an appropriate solvent. The solvent boiling point should be below the thermal transfer temperature. Optimally, the boiling point should be <170° C., more preferably <150° C. The choice of solvent may be influenced by the organic functionalities capping the QDs or the nature of the QD bead material and the choice of additives. The choice of solvent may also be influenced by the choice of printing process. Suitable solvents may include, but are not restricted to, non-polar solvents, including toluene, alkanes (e.g. hexane, octane), xylene, chloroform, anisole, etc., and polar solvents, including alcohols, water, 1-methoxypropan-2-ylacetate (PGMEA), etc.

One or more binder materials are dispersed in the ink formulation. The binder(s) must to be soluble in the same solvent as the QDs/QD beads. Optimally, the binder(s) should have a glass transition temperature (Tg) in the range 85-115° C. The binder(s) must be thermo-fusible, such that during the heat transfer process the QDs and binder(s) are transferred from a first substrate to a second substrate, then upon cooling the binder will set to adhere the QDs to the second substrate. Suitable binders include, but are not restricted to, polystyrene resins, polyester resins, acrylic resins, PU resins, acrylated urethane resins, vinyl chloride resins, vinyl acetate resins, vinyl chloride/vinyl acetate copolymer resins, polyamide resins, silicone modifications of the above, and mixtures of the above. The binder(s) must also appear transparent upon drying.

Typically, the ink formulation will comprise 80-99.9% binder and 0.1-20% QDs and additives dissolved or dispersed in solvent. The ink formulation is prepared by dissolving or dispersing the QDs or QD beads, binder(s) and any desired additional additives into the solvent, either sequentially or concurrently. As used herein, the term dispersing may refer to both dispersing and dissolving, unless otherwise noted. To assist in forming a homogeneous dispersion, any technique known to one skilled in the art may be used including, but not restricted to, stirring, shaking, ultrasonication, gentle heating, etc.

If using QD beads, the binder may be incorporated in the bead material. The ink may be formulated such that bead composition and additives form a cross-linked polymer during the thermal transfer process, to enhance the durability of the transferred image.

The ink is printed onto a first substrate, which may be a commercially available thermal transfer sheet, such as those available for use in domestic ink-jet printers, or any other suitable substrate onto which the ink will adhere upon drying but be released during the heat transfer process.

The ink is printed using any suitable printing technique known in the prior art, including ink-jet printing, doctor blading, screen printing, etc. After printing the image onto the first substrate, the ink is allowed to dry by evaporation of the solvent. Optimally, the ink layer thickness should be less than 5 μm post-solvent evaporation.

The second, transfer substrate is preferably a polymer-based or polymer-coated material, which may include a poly-cotton textile, a laminated wood, polycarbonate, vacuum-form PVC, a self-adhesive polyester, fiber glass, ceramic, or a paper-based material, but can be formed from any material to which the binder(s) can adhere. The substrate must be able to withstand the heat transfer processing conditions.

In one embodiment, the thermal transfer process is conducted using a heat press, which heats the image uniformly and allows precise control of the temperature and pressure. In alternative embodiments, any implement(s) capable of uniformly applying heat and pressure (such as an oven-based system or domestic iron) may be used. The first substrate is positioned face down on the second substrate. Optionally, a sheet of heat-resistant material, such as Teflon, is placed between the first substrate and the heat press; this protects the second substrate, beyond the image transfer region, from heat damage. The operating temperature, pressure and time will depend on the ink formulation and substrate. Typically, temperatures in the region of 160-220° C. are employed. In some embodiments, temperatures below 200° C. are employed to preserve the optical properties of the QDs. The heat and pressure are applied for typically 60-120 seconds. After releasing the press, the substrates are allowed to cool to room temperature, to allow the binder(s) to set. Once cool, the first substrate is carefully peeled from the second substrate to reveal the transferred image. If the image is insufficiently transferred, a higher temperature and/or pressure may be needed. If the quantum dot fluorescence is quenched, a lower temperature may be required.

Following the heat transfer process, optionally a coating can be transferred to the surface of the image to impart additional functionality, such as resistance to mechanical abrasion and/or act a barrier to the passage of free radical species and/or is preferably a moisture barrier so that moisture in the environment surrounding the image cannot contact the semiconductor nanoparticles. For example, the coating may act a barrier to the passage of oxygen or any type of oxidizing agent through to the QD image. Such a coating may be applied using any technique known in the art, which may include heat transfer printing.

The coating may provide a layer of material on a surface of the bead of any desirable thickness, provided it affords the required level of protection. The surface layer coating may be around 1 to 10 nm thick, up to around 400 to 500 nm thick, or more. In some embodiments, layer thicknesses are in the range of 1 nm to 200 nm, for example around 5 nm to 100 nm.

The coating can comprise an inorganic material, such as a dielectric (insulator), a metal oxide, a metal nitride or a silica-based material (e.g. a glass).

The metal oxide may be a single metal oxide (i.e. oxide ions combined with a single type of metal ion, e.g. Al₂O₃), or may be a mixed metal oxide (i.e. oxide ions combined with two or more types of metal ion, e.g. SrTiO₃). The metal ion(s) of the (mixed) metal oxide may be selected from any suitable group of the periodic table, such as group 2, 13, 14 or 15, or may be a transition metal, d-block metal, or lanthanide metal.

Suitable metal oxides are selected from the group consisting of Al₂O₃, B₂O₃, Co₂O₃, Cr₂O₃, CuO, Fe₂O₃, Ga₂O₃, HfO₂, In₂O₃, MgO, Nb₂O₅, NiO, SiO₂, SnO₂, Ta₂O₅, TiO₂, ZrO₂, Sc₂O₃, Y₂O₃, GeO₂, La₂O₃, CeO₂, PrOₓ (x=appropriate integer), Nd₂O₃, Sm₂O₃, EuO_{y} (y=appropriate integer), Gd₂O₃, Dy₂O₃, Ho₂O₃, Er₂O₃, Tm₂O₃, Yb₂O₃, Lu₂O₃, SrTiO₃, BaTiO₃, PbTiO₃, PbZrO₃, BiₘTiₙO (m, n=appropriate integer), BiₐSi_{b}O (a, b=appropriate integer), SrTa₂O₆, SrBi₂Ta₂O₉, YScO₃, LaAlO₃, NdAlO₃, GdScO₃, LaScO₃, LaLuO₃, Er₃Ga₅O₁₃.

Suitable metal nitrides may be selected from the group consisting of BN, AlN, GaN, InN, Zr₃N₄, Cu₂N, Hf₃N₄, SiN_{c} (c=appropriate integer), TiN, Ta₃N₅, Ti—Si—N, Ti—Al—N, TaN, NbN, MoN, WN_{d} (d=appropriate integer), WNₑC_{f} (e, f=appropriate integer).

The inorganic coating may comprise silica in any appropriate crystalline form.

The coating may incorporate an inorganic material in combination with an organic or polymeric material, e.g. an inorganic/polymer hybrid, such as a silica-acrylate hybrid material.

The coating can comprise a polymeric material, which may be a saturated or unsaturated hydrocarbon polymer, or may incorporate one or more heteroatoms (e.g. O, S, N, halo) or heteroatom-containing functional groups (e.g. carbonyl, cyano, ether, epoxide, amide, etc.).

Examples of suitable polymeric coating materials include acrylate polymers (e.g. polymethyl(meth)acrylate, polybutylmethacrylate, polyoctylmethacrylate, alkylcyanoacryaltes, polyethyleneglycol dimethacrylate, polyvinylacetate, etc.), epoxides (e.g. EPOTEK 301 A and B thermal curing epoxy, EPOTEK OG112-4 single-pot UV curing epoxy, or EX0135 A and B thermal curing epoxy), polyamides, polyimides, polyesters, polycarbonates, polythioethers, polyacrylonitryls, polydienes, polystyrene polybutadiene copolymers (Kratons), pyrelenes, polypara-xylylene (parylenes), polyetheretherketone (PEEK), polyvinylidene fluoride (PVDF), polydivinyl benzene, polyethylene, polypropylene, polyethylene terephthalate (PET), polyisobutylene (butyl rubber), polyisoprene, and cellulose derivatives (methyl cellulose, ethyl cellulose, hydroxypropylmethyl cellulose, hydroxypropylmethylcellulose phthalate, nitrocellulose), and combinations thereof.

Thermal Transfer Wax Formulation

For thermal wax transfer, a quantum dot wax can be formulated using a similar procedure to that outlined above, but replacing the binder(s) with a wax. For instance, the QD (bead) solution can be mixed with a paraffin wax in a mutually compatible solvent, e.g. hexane. The quantum dot wax solution can be printed, or the solvent evaporated and the wax transferred onto the thermal transfer paper as a solid, e.g. by rubbing or by pre-forming the image using a molding or cutting technique then gently melting it onto the substrate surface. Suitable first substrates include, but are not restricted, greaseproof or glassine paper.

The thermal transfer process is then carried out as above.

Sublimation Transfer Ink Formulation

For the QDs to be sublimated under the heat transfer conditions, the ink formulation must comprise binder(s) that are non-thermo-fusible, such that the QDs become embedded in the second substrate following the application of heat and pressure, while the binder matrix remains on the first substrate. Suitable binders include, but are not restricted to, cellulose resins, vinyl resins, PU resins, polyamide resins, polyester resins, or mixtures of the above; preferably cellulosic, vinyl acetal, vinylbutyral, or polyester resins, such that the matrix remains on the first substrate after the thermal transfer process.

Additives, such as oils or waxes, can optionally be added to the ink formulation to assist in the release of the QDs from the ink layer.

The heat transfer procedure can be conducted similarly to that described above. If transferring the image onto a suitable polymeric second substrate, following heat transfer the QDs (or QD beads) would become embedded in fibers of the polymer matrix of the second substrate. Thus, the image would be scratch-resistant without having to apply a further protective coating.

### FURTHER EMBODIMENTS

The image printed on the first substrate may comprise one or more inks, where at least one ink contains QDs. In a further embodiment of the present disclosure, a conventional dye can be incorporated into the QD ink formulation, such that the image will appear one color under ambient light and fluoresce a different color under UV irradiation.

Alternatively, the heat transfer process can be repeated by first depositing an image comprising one or more conventional dyes, then over-printing with an image composed of one or more QD dyes, or vice versa. As such two different images will be observed, depending on whether the image is viewed under ambient or UV light.

### APPLICATIONS

The heat transfer process can be used to transfer an image from a printable substrate onto a range of media. Potential applications include anti-counterfeiting, for instance to transfer a fluorescent hologram onto bank notes or credit cards, security badges or uniforms, etc. The hologram could be composed of nanoparticles that emit in the visible and/or infrared region of the electromagnetic spectrum upon irradiation with UV light.

Other applications may include soft-signage, laminated displays, textiles and soft furnishings, which may not be easily printed using conventional techniques, or may suffer from color bleeding if printed with a liquid dye. Using the heat transfer process, since the QD ink is allowed to dry prior to the heat transfer process, bleeding of the ink will be minimized.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of printing, comprising:
providing an ink composition comprising at least a first population of quantum dots (QDs);
depositing the ink on a first substrate to form an image; and
transferring the image onto a second substrate.

2. The method as recited in claim 1, wherein transferring comprises contacting the first substrate and the second substrate and applying heat and pressure to the substrates.

3. The method as recited in claim 1, wherein the first substrate is a thermal transfer sheet.

4. The method as recited in claim 1, wherein the depositing the ink on the first substrate comprises ink-jet printing, doctor blading, or screen printing.

5. The method as recited in claim 1, wherein the second substrate comprises a polymer-based or polymer-coated material.

6. The method as recited in claim 2, wherein the heat and pressure are applied using a heat press.
The method as recited in claim 2, wherein the heat is applied at a temperature of about 160 to about 220° C.

7. The method as recited in claim 2, wherein the heat is applied at a temperature below about 200° C.

8. The method as recited in claim 2, wherein the heat and pressure are applied for a duration of about 60 to about 120 seconds.

9. The method as recited in claim 1, further comprising applying a gas-barrier coating to the surface of the second substrate.

10. The method as recited in claim 1, further comprising a second population of QDs, wherein the first population and the second population of QDs have different emission wavelengths.

11. A quantum dot ink formulation for heat transfer printing, comprising:
a population of quantum dots;
a solvent with a boiling point below about 170° C.; and
a wax.
